(19) United States
(12) Patent Application Publication
(10) Pub. No.: US 2008/0064506 A1
(43) Pub. Date: Mar. 13, 2008

(54) Connector structure for a gearbox linked to a motor

(75) Inventor: Chung-Chuan Lin, Taiping Taichung Hsien (TW)

Correspondence Address: CHARLES E. BAXLEY, ESQ., 90 JOHN STREET, THIRD FLOOR, NEW YORK, NY, 10038, US

(73) Assignee: CHAO YANG ENTERPRISE CO., LTD.

(21) Appl. No.: 11/520,406

(22) Filed: Sep. 12, 2006

(51) Int. Cl. F16D 3/00

(52) U.S. Cl. 464/73

(57) ABSTRACT

a connector structure for a gearbox comprises a transmission rod, a bearing, two connecting members, a buffer, a clamping bush and a rod rack. The buffer is disposed between the two connecting members, the connecting members are received in the clamping bush, and then the clamping bush is installed in the bearing. The connecting members are provided for insertion of a transmission rod and a rod rack, and the buffer prevents the transmission rod from contacting the rod rack and can absorb the vibration generated during the motion transmission cause, and thus the noise is also reduced.

### BACKGROUND OF THE INVENTION

1. Field of the Invention

The present invention relates to a connector structure for a gearbox linked a motor, and more particularly to a connector structure for a gearbox that can reduce the generation of noise and vibration when the motor runs at a high speed.

2. Description of the Prior Art

Referring to FIG. 1, a transmission rod 21 for a conventional gearbox has one end connected to an output end of a motor, and another end of the transmission rod is axially defined with an inserting groove 22. A bearing 10 is disposed at an appropriate position in the gearbox, and a connecting block 23 is received in the bearing 10. The connecting block 23 has a connecting portion 231 formed at an end thereof, another end of the connecting block 23 is axially formed with a groove 232 in which an inserting piece 24 is received. The connecting portion 231 is inserted in the inserting groove 22 of the transmission shaft 21. A connecting groove 251 formed at one end of the rod rack 25 is to be engaged with the inserting piece 24 of the connecting block 23, thus forming a conventional connector structure for a gearbox. And this conventional connector structure has the following disadvantages:

The transmission rod 21 and the rod rack 25 are connected together by the connecting block 23 and the inserting piece 24. When the transmission rod 21 of the motor 2 rotates, the bearing 10 and the connecting block 23 can provided a great enough support, however, as the rotating speed and the resultant vibration increase, the connecting block 23 and the inserting piece 24 are unable to absorb the vibration. As a result, the gradually increased vibration accelerates the wear and tear of the threads on the rod rack 25, and of the threads engaged with the threads of the rod rack 25.

The present invention has arisen to mitigate and/or obviate the afore-described disadvantages.

### SUMMARY OF THE INVENTION

The primary objective of the present invention is to provide a connector structure for a gearbox that can prevent the generation of noise and can absorb the vibration during the cause of motion transmission.

To obtain this objective, two connecting members and a buffer are disposed in a clamping bush, the connecting members are provided for insertion of a transmission rod and a rod rack, and the buffer prevents the transmission rod from contacting the rod rack and can absorb the vibration generated during the motion transmission cause, and thus the noise is also reduced.

### BRIEF DESCRIPTION OF THE DRAWINGS

FIG. 1 is an exploded view of a conventional connector structure;

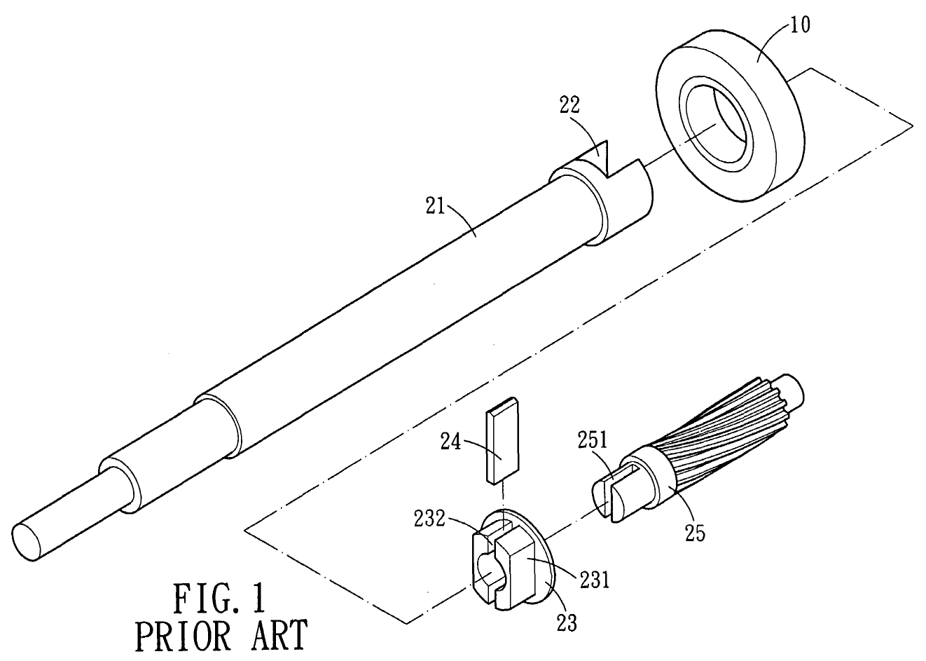

FIG. 2 is a cross sectional view of showing the gearbox and the motor in accordance with the present invention;

FIG. 3 is an exploded view of a connector structure for a gearbox linked to a motor in accordance with the present invention;

FIG. 4 is an exploded view of a transmission rod and a rod rack of the connector structure in accordance with the present invention; and

FIG. 5 is a cross sectional view of the connector structure for a gearbox linked to a motor in accordance with the present invention.

### DETAILED DESCRIPTION OF THE PREFERRED EMBODIMENT

The present invention will be more clear from the following description when viewed together with the accompanying drawings, which show, for purpose of illustrations only, the preferred embodiment in accordance with the present invention.

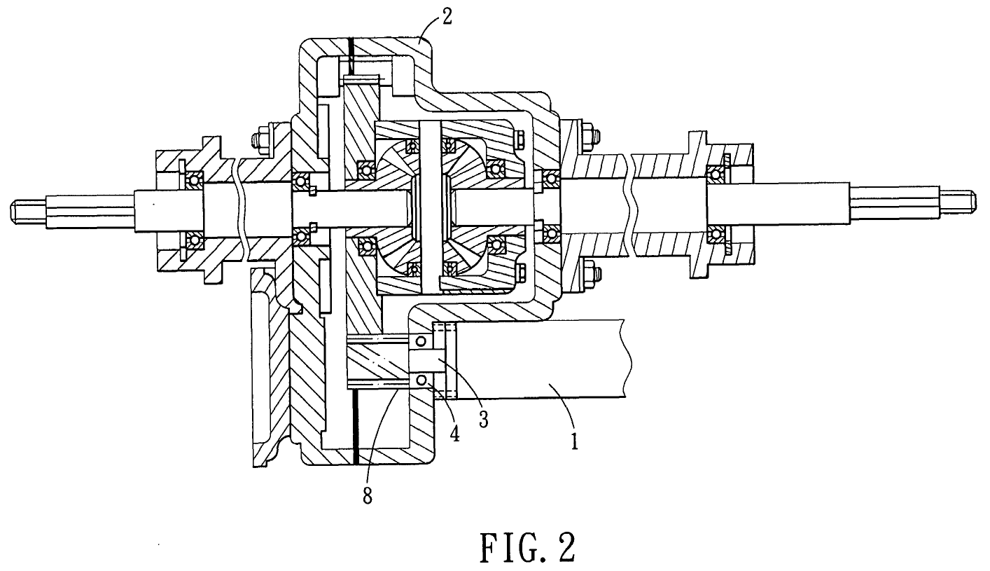

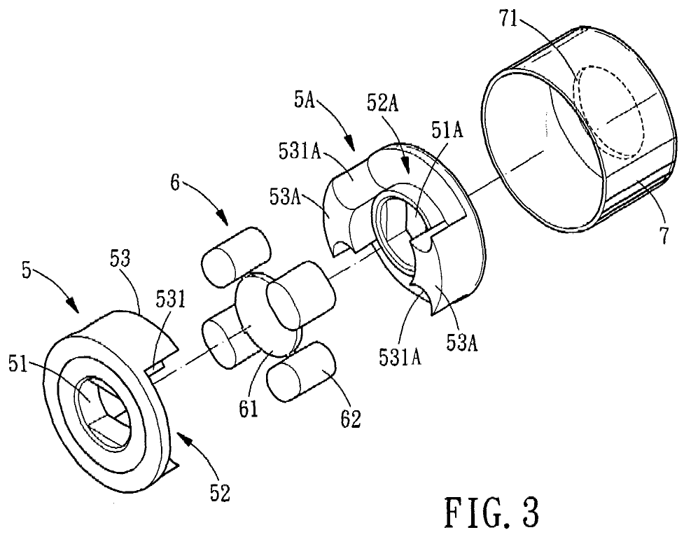

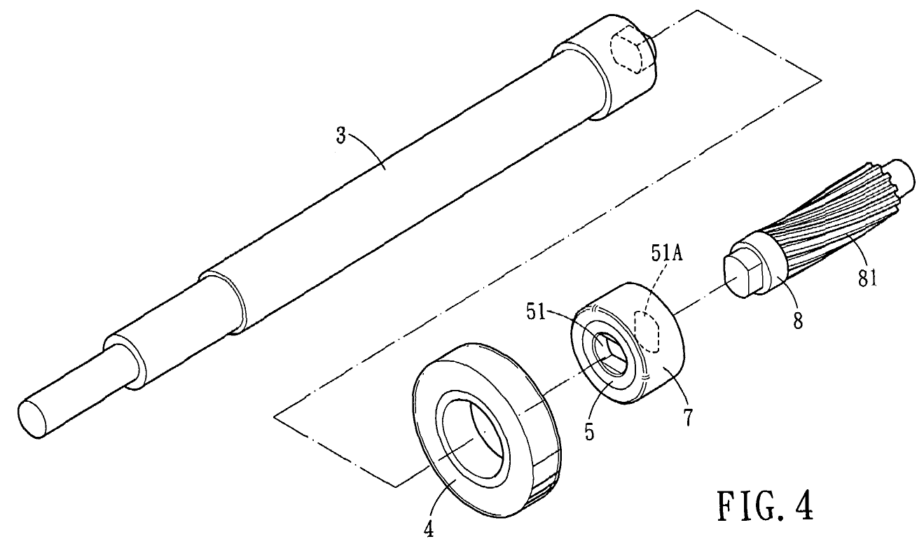

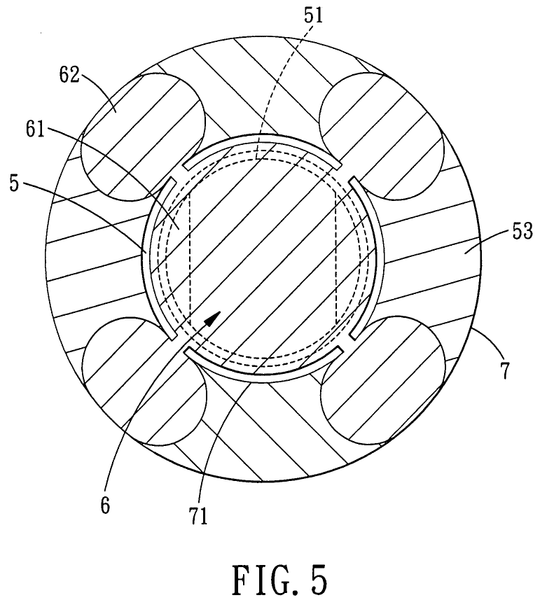

Referring to FIGS. 2-5, a connector structure for a gearbox linked to a motor in accordance with the present invention comprises: a transmission rod 3, a bearing 4, two connecting members 5, 5A, a buffer 6, a clamping bush 7 and a rod rack 8.

The transmission rod 3 has one end connected to an output end of the motor 1.

The bearing 4 is disposed in the gearbox 2.

The connecting members 5, 5A are engaged with each other and each is formed with an elliptical axial hole 51, 51A. Each of the connecting members 5, 5A is formed in its abutting periphery with a concave portion 5, 5A and abutting portions 53, 53A, the abutting portion 53 of one connecting member 5 is to be engaged in the concave portion 52A of the other connecting member 5A (the abutting portion 53A of the connecting member 5A is to be engaged in the concave portion 52 of the other connecting member 5). The elliptical axial holes 51 and 51A are arranged at an angle of 90 degrees relative to each other. Each of the abutting portions 53, 53A is formed in either side thereof facing the concave portions 52, 52A with a semicircular concave 531, 531A. The transmission shaft 3 is inserted in the axial hole 51, 51A of the connecting members 5, 5A.

The buffer 6 is made of plastic material and is received in the concave portion 52 of the connecting member 5 and abuts against the abutting portion 53A of the other connecting member 5A. The buffer 6 includes a circular board 61 and two opposite pairs of pillars 62 formed on the periphery of the circular board 61 for mating with the concaves 531, 531A in the abutting portions 53A, 53 of the connecting members 5, 5A. The clamping bush 7 is a hollow cylindrical structure, the periphery edge at one end of the clamping bush 7 extends toward the axial center of the clamping bush 7 so as to define a through hole 71 located correspondingly to the axial hole 51, 51A of the connecting members 5, 5A. The extended edge and another end of the clamping bush 7 closely press against the outer periphery of the two connecting members 5, 5A. The connecting members 5, 5A fixed in the clamping bush 7 are received in the bearing 7 together with the clamping bush 7.

The rod rack 8 has one end formed with threads 81 and another end inserted in the axial hole of the connecting members 5 and 5A, and the threads 81 are to be engaged with the gears of the gearbox.

For a better understanding of the embodiment, its operation and function, reference should be made particularly to FIGS. 2-4. The transmission rod 3 of the motor 1 is inserted in the axial hole 51 of the connecting member 5, and the rod rack 8 is inserted in the axial hole 51A of the other connecting member 5A. When the motor 1 is actuated, the transmission rod 3 starts to rotate. Since the transmission rod 3 is inserted in the axial hole 51 of the connecting member 5, it will drive the clamping bush 7 to rotate within the bearing 4. When the clamping bush 7 rotates, the other connecting member 5A is caused to rotate. Since the rod rack 8 is inserted in the axial hole 51A of the connecting member 5A, it will rotate along with the rotation of the connecting member 5A, thus rotating the gears of the gearbox 2. therefore, the power produced by the motor 1 can be transmitted to the gearbox 2 via the transmission rod 3, the connecting members 5, 5A and the rod rack 8.

It is to be noted that the transmission rod 3 and the rod rack 8 are inserted in the connecting members 5, 5A, and the buffer 6 between the connecting members 5, 5A can prevent the transmission rod 3 from contacting the rod rack 8, therefore, the clamping bush 7 provide an optimum fulcrum, and the buffer 6 between the connecting members 5 can absorb the vibration generated during the transmission cause. Therefore, the power transmission will be more stable, thus preventing the vibration-caused wear and tear of the threads. Since the decrease of the vibration, the noise will correspondingly be decreased.

While we have shown and described various embodiments in accordance with the present invention, it is clear to those skilled in the art that further embodiments may be made without departing from the scope of the present invention.

What is claimed is:

1. A connector structure for a gearbox linked to a motor comprising:
two connecting members each having an axial hole for connecting the gearbox and the motor, each connecting member being formed in its abutting periphery with concave portion and abutting portions, the abutting portions of one connecting member engaged in the concave portion of the other connecting member;
a buffer being received in the concave portions of the one connecting member and abuts against the abutting portions of the other connecting member; and
a clamping bush for connecting the two connecting members in a clamping manner and having a through hole.

2. The connector structure as claimed in claim 1, wherein the axial hole of the connecting member is elliptical.

3. The connector structure as claimed in claim 1, wherein each of the abutting portions of the respective connecting member is formed in either side thereof facing the concave portion with a semicircular concave.

4. The connector structure as claimed in claim 3, wherein the buffer includes a circular board and two opposite pairs of pillars formed on a periphery of the circular board for mating with the concaves in the abutting portions of the connecting members.

5. The connector structure as claimed in claim 1, wherein a peripheral edge at an end of the clamping bush extends toward the axial center of the clamping bush so as to define the through hole, the two connecting members are connected by the clamping bush in such a manner that the two connecting members are received in the clamping bush, and the extended peripheral edge and another end of the clamping bush closely press against the outer periphery of the two connecting members.
